(19) United States
(12) Patent Application Publication
(10) Pub. No.: US 2011/0310050 A1
(43) Pub. Date: Dec. 22, 2011

(54) Dual-view display operating method

(75) Inventor: Chiu-Lin Chiang, Taipei City (TW)

(73) Assignee: HOLY STONE ENTERPRISE CO., LTD., Taipei City (TW)

(21) Appl. No.: 12/801,586

(22) Filed: Jun. 16, 2010

(51) Int. Cl. G06F 3/044; G06F 3/041

(52) U.S. Cl. 345/174; 345/173

(57) ABSTRACT

A dual-view display operating method for operating a dual-view display that delivers different images to viewers on the right and left respectively and that has multiple sensors in multiple peripheral sides thereof by: sensing the approaching of an object by the sensors to produce a heading value corresponding to the direction of the presence of the object, and then coupling and computing all received sensing signals from the sensors to produce an operating parameter for running an air gesture application procedure. Thus, using the dual-view display can execute multiple operating procedures, saving the hardware cost and enhancing operational flexibility.

### BACKGROUND OF THE INVENTION

1. Field of the Invention

The present invention relates to a method of operating an electronic device and more particularly, to a dual-view display operating method, which allows control of different video frames displayed on the screen in different angles of view by different persons at different sides without any mechanical buttons or remote control means.

2. Description of the Related Art

Following fast development of the modern technology\, many different kinds of displays, such as LCD (liquid crystal display) and OLED (organic light emitting diode) have entered into our daily life. Conventional displays are single view displays that deliver one single image to viewers viewing in different angles of view. When different users wish to view different image contents, a software or hardware is necessary for switching the display. Nowadays, multi-view displays have been created to deliver images to viewers in different angles of view. A dual-view display TV solves the TV channel squabble.

When one user views a dual-view display in a first angle of view, a first video frame is shown on the screen. When another user views the dual-view display in a second angle of view at the same time, a second video frame is shown on the screen. A dual-view display has switching means that functions as a parallax barrier that separates the direction of light from each pixel of the LCD panel into two directions. Thus, people on the left and on the right can see different view frames displayed on the screen of the dual-view display. Taiwan Publication No. 200919395 discloses a similar design.

When using a dual-view display in a car, the driver and the passenger can enjoy different image contents displayed on the screen of the dual-view display in different angles of view. For example, the driver on the left can view a first video frame relating navigation parameters (for example, GPS navigation view frame), the passenger on the right can view a second video frame (for example, TV program). Thus, people in a car can enjoy different TV programs or view different information.

Further, following the development of non-mechanical control technology, such as touch control technology, a user can touch the screen to achieve a click function. This touch control technology eliminates an extra mechanical switching structure, saving the cost. Employing touch control technology to display panels saves hardware cost and enhances use convenience. However, using touch control technology in a regular dual-view display may encounter a touch judgment confusion, i.e., the dual-view display cannot judge which user made the touch for controlling which video frame displayed. Thus, the dual-view display cannot determine the relative application program. To avoid this problem, extra mechanical buttons shall be installed in the dual-view display or an extra remote control device shall be used for selection control. However, installing extra mechanical buttons or using an extra remote control device relatively increases the cost.

Therefore, it is desirable to provide a dual-view display operating method, which eliminates the aforesaid drawbacks.

### SUMMARY OF THE INVENTION

The present invention has been accomplished under the circumstances in view. It is one object of the present invention to provide a dual-view display operating method, which allows control of different video frames displayed on the screen in different angles of view by different persons at different sides without any mechanical buttons or remote control means. It is another object of the present invention to provide a dual-view display operating method, which enhances the flexibility in use of a dual-view display.

To achieve these and other objects of the present invention, a dual-view display operating method, which enables a user to operate a dual-view display having multiple sensors in multiple peripheral sides thereof by: approaching an object to the sensor at one of two opposing sides corresponding to one of two video frames displayed on the screen for causing the sensor to provide a sensing signal for producing a heading value, and then computing all received sensing signals from all the sensors to produce an operating parameter (that contains the data of, but not limited to, touch location, object moving direction, object distance and object moving speed) for running an application procedure. Thus, different users can operate different video frames displayed on the screen without through any mechanical buttons or remote control means, saving the hardware cost and enhancing the operational flexibility.

Further, when the approaching object touches the screen after the object has been sensed by one sensor in one side of the dual-view display to provide a sensing signal for producing a heading value corresponding to the direction of the presence of the sensed object for the selection of the respective application procedure for controlling the respective video frame displayed on the screen, it couples the heading value and the touch location thus obtained, and then runs a touch control application procedure.

Further, if the approaching object does not touch the screen after having been sensed by one sensor in one side of the dual-view display to provide a sensing signal for producing a heading value, it determines the moving direction and moving speed of the continuously sensed object, and then couples and computes all sensing signals to produce an operating parameter, and then runs an air gesture application procedure subject to the operating parameter. Thus, the invention achieves versatile control.

### BRIEF DESCRIPTION OF THE DRAWINGS

FIG. 1 is a flow chart of a dual-view display operating method in accordance with a first embodiment of the present invention.

FIG. 2 is a schematic applied view of the first embodiment of the present invention (I).

FIG. 3 is a schematic applied view of the first embodiment of the present invention (II).

FIG. 4 is a circuit block diagram of the present invention.

FIG. 5 is a flow chart of a dual-view display operating method in accordance with a second embodiment of the present invention.

FIG. 6 is a schematic applied view of the second embodiment of the present invention.

### DETAILED DESCRIPTION OF THE PREFERRED EMBODIMENT

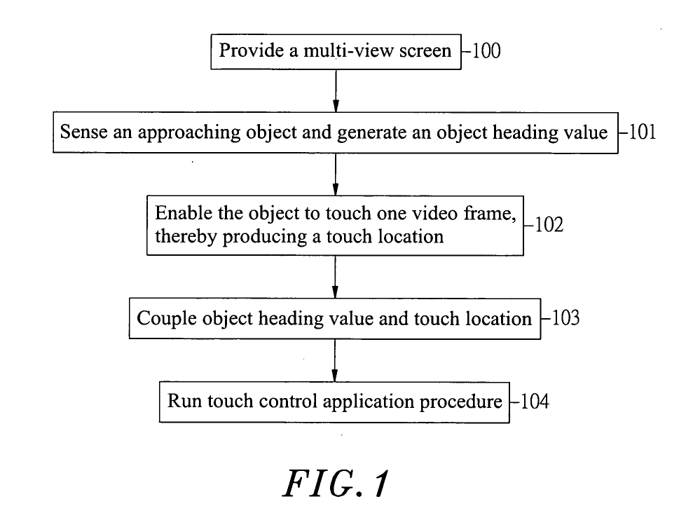

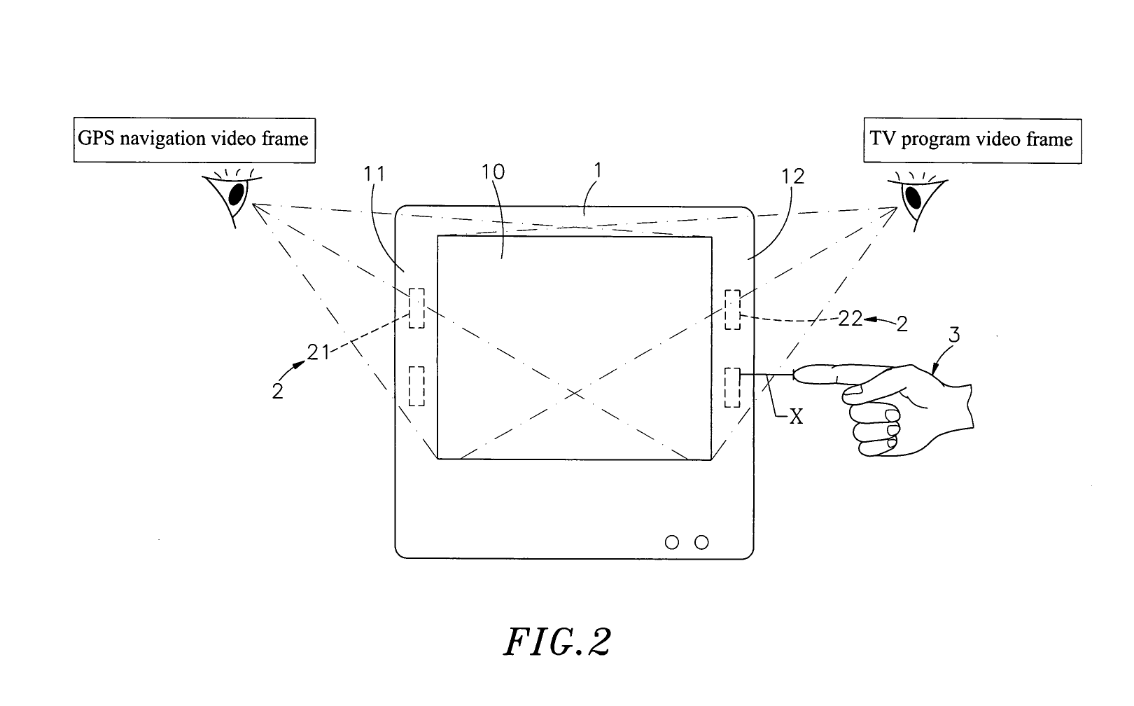

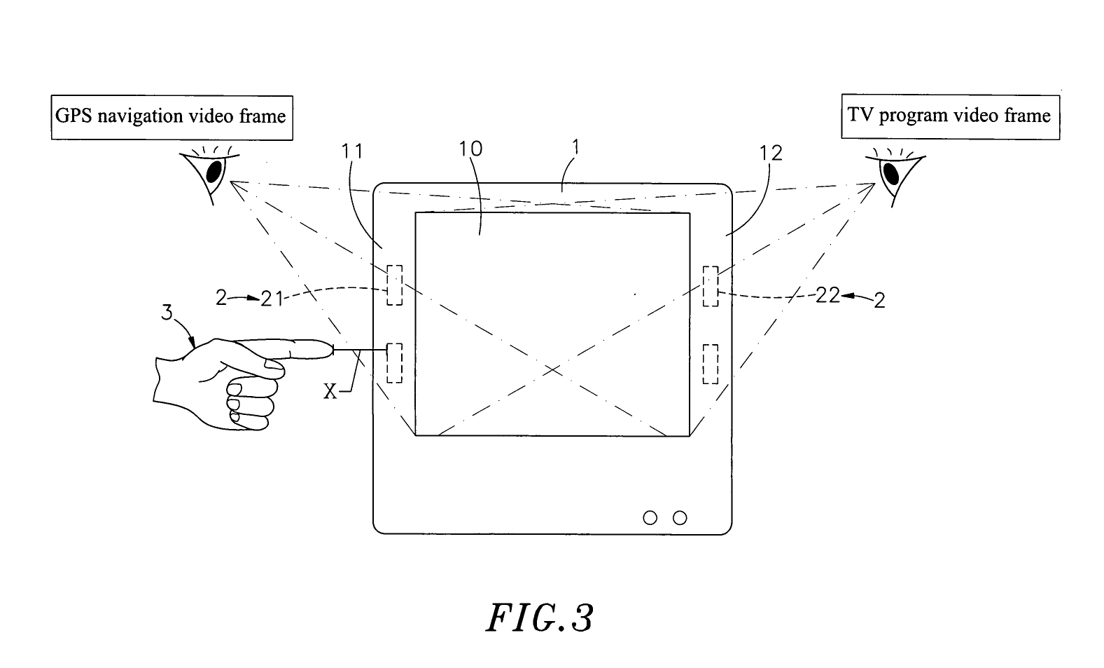

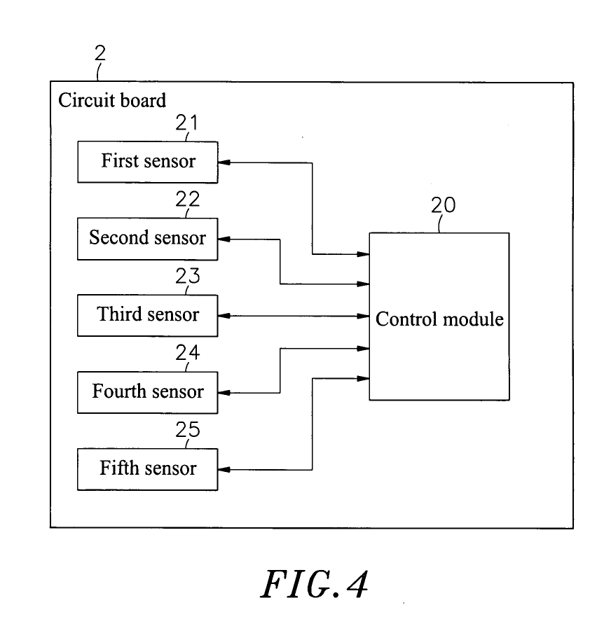

Referring to FIGS. 1, 2, 3 and 4, a dual-view display operating method for use with a dual-view display 1 in accordance with a first embodiment of the present invention is shown. According to this first embodiment, the dual-view display 1 comprises a screen 10. Two opposing sides of the screen 10 are defined as the first peripheral side 11 and the second peripheral side 12. The dual-view display 1 further comprises at least one first sensor 21 installed in the first peripheral side 11, and at least one second sensor 22 installed in the second peripheral side 12. The sensors 21;22 can be capacitive sensors or infrared sensors. Exemplars of these sensors can be seen in U.S. Pat. Nos. 7,498,749; 7,443,101; 7,336,037.

The screen 10 of the dual-view display 1 delivers different images to viewers on the right and left respectively. For example, the dual-view display 1 can be used in a car so that one person in the car can see a first video frame (for example, GPS navigation map) on the screen 10 in a first angle of view, another person in the car can view a second video frame (for example, TV program) on the screen 10 in a second angle of view. In this case, the first angle of view is defined to be at the first peripheral side 11 of the dual-view display 1; the second angle of view is defined to be at the second peripheral side 12 of the dual-view display 1. Thus, different users can operate the dual-view display 1 from different sides to control the corresponding view frame.

The dual-view display operating method in accordance with the first embodiment of the present invention includes the steps of:
(100) Provide a multi-view screen 10 that has at least one sensor mounted in each of two opposing sides thereof, and then provide at least one object 3 for approaching the sensors of the multi-view screen 10 to produce sensing signals;
(101) Enable the at least one sensor in one peripheral side of the multi-view screen 10 to sense the presence of the approaching object 3 and to produce a sensing signal for producing a heading value corresponding to the direction of movement of the sensed object;
(102) Enable the object 3 to touch one video frame displayed on the multi-view screen 10 to produce a touch location;
(103) Couple the heading value and the touch location; and
(104) Run a touch control application procedure.

According to this embodiment, a first video frame and a second video frame can be seen on the screen 10 of the multi-view display 1 in the first angle of view at the first peripheral side 11 of the dual-view display 1 and in the second angle of view at the second peripheral side 12 of the dual-view display 1 respectively. When one object 3, for example, a first user's finger enters a range X, for example, within 10˜25 cm from the first peripheral side 11, the first sensor 21 senses the presence of the first user's finger and then provides a sensing signal for producing a corresponding heading value relative to the direction of the approaching object 3. The first sensor 21 is electrically connected to the control module 20 at the circuit board 2 in the dual-view display 1. Subject to the sensing signal produced by the first sensor 21, the control module 20 judges that the approaching object 3 is at the first peripheral side 11 of the dual-view display 1. Relatively, when another object 3, for example, a second user's finger enters a range X, for example, within 10˜25 cm from the second peripheral side 12, the second sensor 22 senses the presence of the second user's finger and then provides a sensing signal for producing a corresponding heading value relative to the direction of the approaching object 3. The second sensor 22 is electrically connected to the control module 20 at the circuit board 2 in the dual-view display 1. Subject to the sensing signal produced by the second sensor 22, the control module 20 judges that the approaching object 3 is at the second peripheral side 12 of the dual-view display 1. Thus, the control module 20 accurately judges the direction of an approaching object 3 subject to the heading value produced, and then stores the heading value in a built-in memory, or an external memory that is electrically connected to the control module 20.

When going to control a further function of one of two video frames displayed on the screen 10 of the dual-view display 1, the approaching object 3 must touch the surface of the screen 10. When the object 3 touches the screen 10, an operating parameter of touch signal is produced and transmitted to the control module 20 so that the control module 20 can determine the touch location, and then couple the heading value and the touch location, and then run a touch control application procedure subject to the coupling result.

For example, a user in the driver's seat in a car can see a GPS navigation map displayed on the screen 10 in the first angle of view. If the driver of the car wishes to zoom in one particular spot of the GPS navigation map displayed on the screen 10, the driver can move one finger into the sensing range X of the first sensor 21 in the first peripheral side 11 of the dual-view display 1. At this time, the first sensor 21 senses the presence of the driver's finger, and then provides a sensing signal to the control module 20. Upon receipt of the sensing signal received from the first sensor 21, the control module 20 analyzes the received sensing signal and produces a corresponding heading value, and then stores the heading value. When the driver's finger touches the screen 10, the control module 20 couples the heading value and the touch location, and then run an application procedure of the GPS navigation software program subject to the data of the coupling result. On the other hand, another user in the assistant driver seat in the car can see a TV program displayed on the screen 10 in the second angle of view. If the assistant driver of the car wishes to select TV channels, the assistant driver can move one finger into the sensing range X of the second sensor 22 in the second peripheral side 12 of the dual-view display 1. At this time, the second sensor 22 senses the presence of the assistant driver's finger, and then provides a sensing signal to the control module 20. Upon receipt of the sensing signal received from the second sensor 22, the control module 20 analyzes the received sensing signal and produces a corresponding heading value, and then stores the heading value. When the assistant driver's finger touches a next channel selection button on the video frame displayed on the screen 10, the control module 20 couples the heading value and the touch location, and then run an application procedure of the TV player software program subject to the data of the coupling result. Thus, different user can watch different video frames displayed on the screen 10 at the same time, and then touch the screen 10 to control different video frames for different functions directly without through any mechanical button or remote control means. Thus, the invention effectively reduces hardware installation cost.

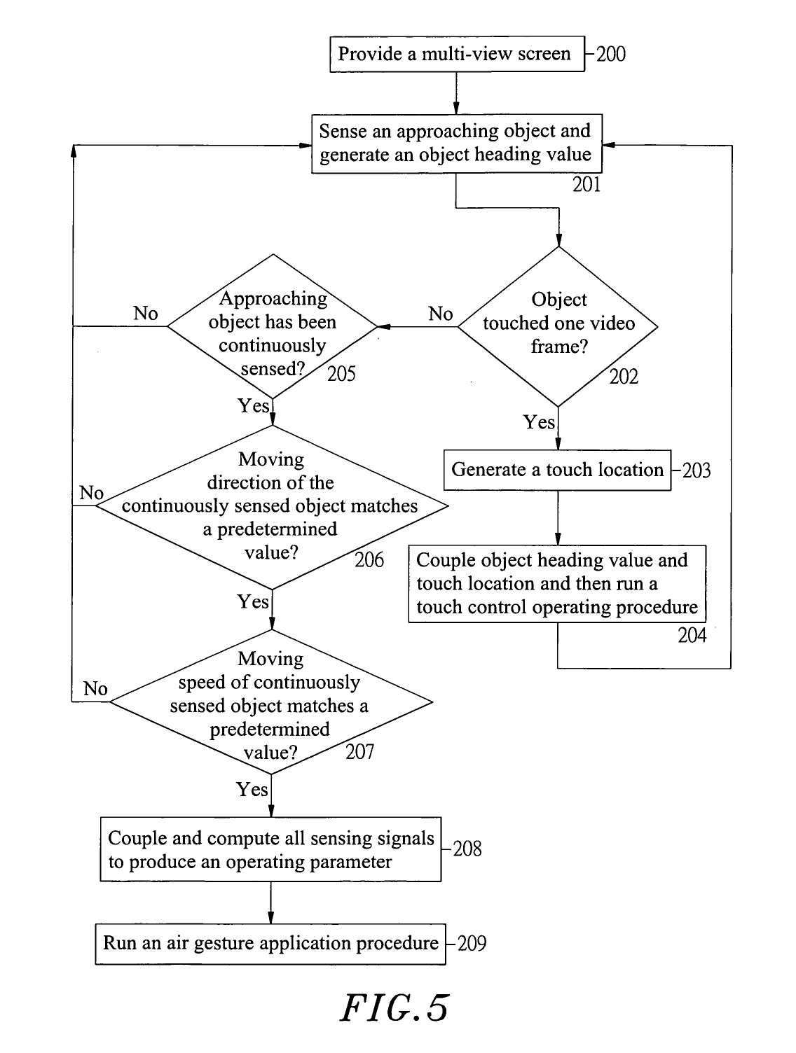

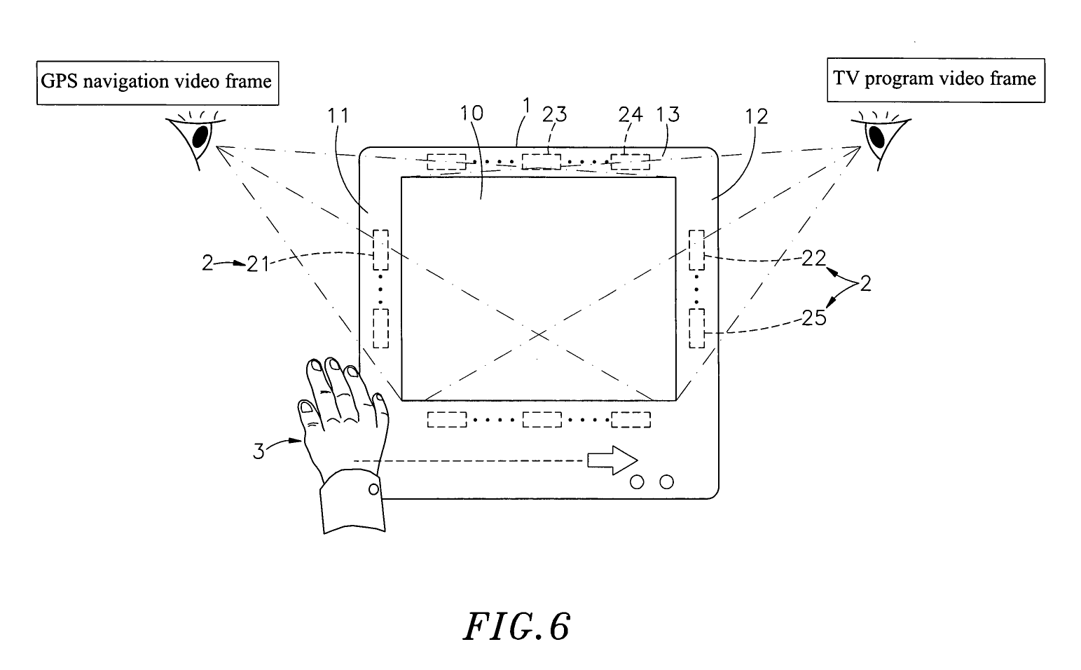

FIGS. 5 and 6 show a dual-view display operating method for use with a dual-view display 1 in accordance with a second embodiment of the present invention. According to this second embodiment, the dual-view display 1 comprises a screen 10, and at least one first sensor 21 installed in each of opposing first and second peripheral sides 11;12 of the dual-view display 1. When an object 3 is approaching or touch the screen 10, a corresponding application procedure is performed in the same manner as the aforesaid first embodiment.

This second embodiment has an air gesture recognition function so that one user at either of the two opposite peripheral sides relative to the dual-view display 1 can control one respective video frame displayed on the screen 10 without direct contact. The dual-view display operating method according to this second embodiment comprises the steps of:
(200) Provide a multi-view screen 10 that has at least one sensor mounted in each of two opposing peripheral sides thereof, and then provide at least one object 3 for approaching the sensors of the multi-view screen 10 to produce sensing signals;
(201) Enable the at least one sensor in a first peripheral side of the multi-view screen 10 to sense the presence of the approaching object 3 and to produce a sensing signal for producing a heading value corresponding to the direction of movement of the sensed object;
(202) Determine whether or not the approaching object 3 has touched one video frame displayed on the multi-view screen 10? And then proceed to step (203) when positive, or step (205) when negative;
(203) Generate a touch location;
(204) Couple the heading value and the touch location, and then run a touch control application procedure, and then return to step (201);
(205) Determine whether or not the approaching object 3 has been continuously sensed? And then proceed to step (206) when positive, or return to step (201) when negative;
(206) Determine whether or not the moving direction of the continuously sensed object 3 matches a predetermined value? And then proceed to step (207) when positive, or return to step (201) when negative;
(207) Determine whether or not the moving speed of the continuously sensed object 3 matches a predetermined value? And then proceed to step (208) when positive, or return to step (201) when negative;
(208) Couple and compute all sensing signals to produce an operating parameter; and
(209) Run an air gesture application procedure.

According to this second embodiment, a first video frame and a second video frame can be seen on the screen 10 of the multi-view display 1 in the first angle of view at the first peripheral side 11 of the dual-view display 1 and in the second angle of view at the second peripheral side 12 of the dual-view display 1 respectively. When one object 3, for example, a first user's finger enters a range X relative to the first peripheral side 11, the first sensor 21 senses the presence of the first user's finger and then provides a sensing signal for producing a corresponding heading value relative to the direction of the approaching object 3. Subject to the sensing signal produced by the first sensor 21, the control module 20 judges that the approaching object 3 is at the first peripheral side 11 of the dual-view display 1. Relatively, when another object 3, for example, a second user's finger enters a range X relative to the second peripheral side 12, the second sensor 22 senses the presence of the second user's finger and then provides a sensing signal for producing a corresponding heading value relative to the direction of the approaching object 3. Subject to the sensing signal produced by the second sensor 22, the control module 20 judges that the approaching object 3 is at the second peripheral side 12 of the dual-view display 1. Thus, the control module 20 accurately judges the direction of an approaching object 3 subject to the heading value produced, and then stores the heading value in a built-in memory, or an external memory that is electrically connected to the control module 20.

Thereafter, the control module 20 determines whether or not the approaching object 3 has touched the surface of the screen 10 within a predetermined time period? If the approaching object 3 does not touch the surface of the screen 10, it is determined that the user is making an air gesture control, i.e. the dual-view display 1 will enter an air gesture recognition mode. Under this air gesture recognition mode, a third sensor 23 and a fourth sensor 24 in a third peripheral side 13 and the second sensor 22 and a fifth sensor 25 in the second peripheral side 12 are activated to sense the movement of the approaching object 3 for producing an operating parameter subject to the sensing signals received from the activated sensors through a computation. The sensing signal produced by each activated sensor comprises the data of, but not limited to, distance, direction and speed. The computation is made subject to the formula of:

Ag=S₁{f(d),f(t)}˜S₂{f(d),f(t)} . . . S_{y}{f(d),f(t)}

where:

Ag (air gesture operation)=the operating parameter;

S=sensor;

S₁=the first sensor;

S₂=the second sensor;

S_{y}=the y^{th} sensor;

f(d)=the distance between the sensed object 3 and the sensor sensing the object 3;

f(t)=the moving time from one sensor to a next sensor.

Calculation of the moving time is made by: defining the time of the first contact to be the first time point t₁ and the time of the last contact to be the second time point t₂, and then obtaining the moving time by the formula of t₂−t₁. Thus, the control module 20 can couple and analyze the sensing signals received from the sensors to produce an operating parameter. According to the present preferred embodiment, the operating parameter comprises the data of, but not limited to, the moving direction of the sensed object 3, the distance between the sensed object 3 and the respective sensor, and the moving speed of the sensed object 3. Subject to the operating parameter thus produced, an air gesture application program is performed.

In this second embodiment, the arrangement of the third sensor 23 and fourth sensor 24 in the third peripheral side 13 and the second sensor 22 and fifth sensor 25 in the second peripheral side 12 is simply an example of the present invention. However, this example is simply for the purpose of illustration only but not for use as a limitation. According to the aforesaid operation flow, the control module 20 determines whether or not the object 3 has been continuously sensed by the third sensor 23 and fourth sensor 24, or the second sensor 22 and fifth sensor 25 within a predetermined time period? When the object 3 is continuously sensed by, for example, the third sensor 23 and fourth sensor 24 within a predetermined time period, the control module 20 will receive sensing signals Ag=S₃{f(d),f(t)}·S₄{f(d),f(t)}. Thereafter, the control module 20 determines the moving direction of the object 3 subject to the sequence of the sensing signals received. Subject to the aforesaid calculation formula, it is known that the object 3 moves from the left toward the right. Thereafter, the distance between the object 3 and the third sensor 23 and the distance between the object 3 and the fourth sensor 24 are determined subject to f(d). Thereafter, subject to f(t), the moving speed of the object 3 is determined to be in conformity with the set value or not. For example, if the time period from the first time point t₁ to the second time point t₂ is 5˜6 seconds and the distances between the object 3 and the second sensor 22 and fifth sensor 25 are equal and all to be 5 cm, it is determined to be an operation for volume control.

On the other hand, when the control module 20 received sensing signals from the second sensor 22 and fifth sensor 25 within a predetermined time period, the time period from the first time point t₁ to the second time point t₂ during movement of the object 3 is shorter than one second, and the distances between the object 3 and the third sensor 23 and fourth sensor 34 are equal and all to be 5 cm, thus it is determined to be a command from the user in the assistant driver seat for turning to the next page. However, it is to be understood that the above explanation is simply an example of the present invention and shall not be considered to be limitations of the invention.

According to the present invention, the dual-view display 1 has stored therein multiple operating parameters, for example, the parameter for next page operation control or the parameter for volume control. Further, the invention uses the control module 20 to receive sensing signals from the sensors, and uses a formula to compute the content of the sensing signals. If the content of one sensing signal obtained through computation matches one pre-set operating parameter, the control module 20 executes the corresponding application program and operating software procedure. Thus, the different users viewing different video frames displayed on the dual-view display 1 can input control signals into the dual-view display 1 by touch, or by means of air gesture, enhancing operational flexibility.

Further, when one object 3 enters a predetermined range relative to the dual-view display 1, the sensors provide a respective sensing signal to the control module 20, causing the control module 20 to start up power supply for the other modules of the dual-view display 1, waking up the other modules of the dual-view display 1 from standby mode into the operating mode. Thus, power consumption is minimized when the dual-view display 1 is not operated.

In conclusion, the invention provides a dual-view display operating method, which has advantages and features as follows:
1. The dual-view display operating method of the present invention allows different persons viewing different video frames simultaneously displayed on a dual-view display to operate the dual-view display by touch control, or by air gesture without direct contact. The dual-view display 1 has multiple sensors installed in multiple peripheral sides thereof. When a designated object 3 enters the sensing range of one sensor, the control module 20 of the dual-view display 1 determines the sensing of the sensors is a continuous sensing or not, and then determines whether or not the sensing signals of the sensors match predetermined values, for example, moving direction and moving speed, and then couples and analyzes all the received sensing signals to produce an operating parameter, and then runs an application procedure subject to the operating parameter. Thus, it is not necessary to install mechanical buttons in the dual-view display 1, or to use a remote control device. Therefore, using the dual-view display 1 can execute multiple operating procedures, saving the hardware cost and enhancing operational flexibility.
2. The operating method of the present invention includes a touch control operation mode and an air gesture operation mode. Upon sensing of the presence of an object 3, object direction is determined, and then the application procedure to be performed is determined. Thereafter, it is determined whether or not the approaching object has touched the surface of the screen 10? The corresponding touch control operating procedure will be performed when a touch control is determined. If the approaching object does not touch the screen 10, it will enter the air gesture operating procedure. Thus, the invention provides the dual-view display 1 with multiple control modes.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A dual-view display operating method, comprising the steps of:
(a) Provide a multi-view display having multiple sensors in multiple peripheral sides thereof, and then provide at least one object for approaching said sensors of said electronic device to produce sensing signals;
(b) Enable one said sensor in one peripheral side of said multi-view screen to sense the presence of the approaching of one said object and to produce a sensing signal for producing a heading value corresponding to the direction of the presence of the sensed object;
(c) Enable the approaching object to touch one video frame displayed on said multi-view screen for causing said multi-view screen to produce a touch location;
(d) Couple the heading value and the touch location thus obtained; and
(e) Run a touch control application procedure.

2. The dual-view display operating method as claimed in claim 1, wherein sensing the approaching of one said object in step (a) is achieved by means of the sensing operation of said sensors to detect the presence of one said object within a predetermined range X relative to one said sensor.

3. The dual-view display operating method as claimed in claim 1, wherein the heading value obtained in step (b) is determined subject to the location of the sensor in said multi-view screen that senses the presence of the approaching object.

4. The dual-view display operating method as claimed in claim 1, wherein the sensors provided in step (a) are selected from a group consisting of capacitive sensors and infrared sensors.

5. The dual-view display operating method as claimed in claim 1, wherein when one said object is sensed by one said sensor in step (b), said multi-view display is switched from a power-saving mode to an operating mode.

6. A dual-view display operating method, comprising the steps of:
(a) Provide a multi-view display having multiple sensors in multiple peripheral sides thereof, and then provide at least one object for approaching said sensors of said electronic device to produce sensing signals;
(b) Enable one said sensor in a first peripheral side of said multi-view screen to sense the presence of the approaching of one said object and to produce a sensing signal for producing a heading value corresponding to the direction of the presence of the sensed object;
(c) Determine whether or not the approaching object has touched one video frame displayed on said multi-view screen? And then proceed to step (d) when positive, or step (g) when negative;
(d) Generate a touch location;
(e) Couple the heading value and the touch location thus obtained, and then run a touch control application procedure, and then return to step (a);
(f) Determine whether or not the approaching object has been continuously sensed? And then proceed to step (h) when positive, or return to step (a) when negative;
(g) Determine whether or not the moving direction of the continuously sensed object matches a predetermined value? And then proceed to step (i) when positive, or return to step (a) when negative;
(h) Determine whether or not the moving speed of the continuously sensed object matches a predetermined value? And then proceed to step (j) when positive, or return to step (a) when negative;
(i) Couple and compute all sensing signals to produce an operating parameter; and
(j) Run an air gesture application procedure

7. The dual-view display operating method as claimed in claim 6, wherein sensing the approaching of one said object in step (a) is achieved by means of the sensing operation of said sensors to detect the presence of one said object within a predetermined range X relative to one said sensor.

8. The dual-view display operating method as claimed in claim 6, wherein the sensors provided in step (a) are selected from a group consisting of capacitive sensors and infrared sensors.

9. The dual-view display operating method as claimed in claim 6, wherein the heading value obtained in step (b) is determined subject to the location of the sensor in said multi-view screen that senses the presence of the approaching object.

10. The dual-view display operating method as claimed in claim 6, wherein when one said object is sensed by one said sensor in step (b), said multi-view display is switched from a power-saving mode to an operating mode.

11. The dual-view display operating method as claimed in claim 6, wherein step (j) of coupling and computing all received sensing signals to produce an operating parameter is done by means of the calculation formula of Ag=S₁{f(d),f(t)}·S₂{f(d),f(t)} . . . S_{y}{f(d),f(t)}, where: Ag (air gesture operation)=the operating parameter; S=sensor; S₁=the first sensor; S₂=the second sensor; S_{y}=the y^{th} sensor; f(d)=the distance between the sensed object and the respective sensor; f(t)=the moving time from one sensor to a next sensor.
